(19) United States
(12) Patent Application Publication
(10) Pub. No.: US 2023/0116966 A1
(43) Pub. Date: Apr. 20, 2023

(54) A DUAL PERIPHERAL DEVICE

(71) Applicants: Alan Buzzell, Leesburg, FL (US); Joseph Heath, Leesburg, FL (US)

(72) Inventors: Alan Buzzell, Leesburg, FL (US); Joseph Heath, Leesburg, FL (US)

(21) Appl. No.: 17/504,068

(22) Filed: Oct. 18, 2021

(51) Int. Cl. G06F 3/0346; G06F 3/01; G06F 3/041; G06K 9/00; G05G 9/047

(52) U.S. Cl. CPC G06F 3/0346; G05G 9/047; G06F 3/011; G06F 3/041; G06K 9/00006; G05G 2009/04774; G06F 2203/0332; G06F 2203/0336

(57) ABSTRACT

A peripheral device for a computer is disclosed, including a housing including an interior to contain a fusion sensor in electrical communication with a one or more control elements, the control elements may include a thumb stick, an index pad, a trigger, and a first and second thumb button to each interface with the thumb. The fusion sensor includes a gyroscope, an accelerometer, and a compass each to sense motion of the peripheral device, wherein the fusion sensor and control elements provide input to a cursor displayed on a computing device.

### CROSS-REFERENCE TO RELATED APPLICATIONS

The present application claims priority to U.S. Provisional Pat. Application No. 63/066,767 filed Aug. 17, 2020, entitled “DUEL EDGE CONTROL SYSTEM,” which is hereby incorporated by reference in its entirety.

### TECHNICAL FIELD

Embodiments of the invention relate to peripheral devices for a computer and more particularly to a controller in communication with a computer device to allow a user to manually control and command a computer program product.

### BACKGROUND

Peripheral devices are auxiliary devices used to put information into and get information out of a computer. Peripheral devices may refer to hardware components that are attached to a computer and are controlled by the computer system but are not the core components of the computer (e.g., the CPU or power supply unit). In particular, input devices send data or instructions to the computer. These devices can include the mouse, keyboard, joystick, graphic tablets, image scanners, barcode readers, game controllers, microphones, GPS, sound cards, video cards, and webcams. Output devices include the computer monitor, projector, printer, headphones, LED lights, haptic feedback mechanisms, and speakers. Input/output devices perform both input and output functions and may include the computer data storage device (e.g., a disk drive, solid-state drive, USB flash drive, memory card, etc.), network adapter and multi-function printer.

Input devices provide data and control signals to an information processing system such as the computer These devices can be further categorized by their modality of input (e.g., mechanical motion, audio, visual, etc.), whether the input is discrete (e.g., the pressing of a key) or continuous (e.g., a mouse’s position), and the number of degrees of freedom involved (e.g., two-dimensional mouse movements, three-dimensional navigation, etc.).

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a peripheral device for a computer, including a housing having an interior to contain electrical components in electrical communication with a one or more control elements, the control elements comprising at least one of a thumb stick to interface with a thumb, a control surface to interface with an index finger, a trigger to interface with a middle finger, a first and second thumb button to each interface with the thumb, and a touchpad in electrical communication with a pressure sensor to sense pressure applied by a user.

A pair of peripheral devices may be used by the user in their left and right hands. The first and second peripheral devices may then be used in tandem to provide input to a computing device such as to control a cursor, input movement into a virtual and/or augmented reality interface, to write, to type (i.e., to operate as a keyboard), and provide other computer functions and controls. One skilled in the arts will readily understand that while a single peripheral device or dual peripheral devices may be operated by the user at the same time.

In one aspect, the peripheral device includes an adjustable thumb pad to accommodate various hand sizes, wherein the thumb pad is loosened to allow a sliding joint to extend or retract the housing.

In one aspect, the peripheral device includes an adjustable palm horn adjustably connected to the housing to accommodate various hand sizes.

In one aspect, the peripheral device is provided as a pair of devices, including a first peripheral device and a second peripheral device, the first device configured to be operated by a right hand and the second device configured to be operated by a left hand.

In one aspect, the first device and the second device are operated in tandem to provide simultaneous input to the computer.

In one aspect, the peripheral device operates an augmented reality application operable via the computer.

In one aspect, the peripheral device operates a virtual reality application operable via the computer.

In one aspect, the peripheral device includes a fingerprint sensor to analyze the fingerprint of the user.

In one aspect, the peripheral device includes a finger guard to prevent inadvertent contact with a work surface or keyboard.

Many computer operators use multiple peripheral devices while interacting with the computer. For example, the user may utilize a mouse and keyboard while gaming. This can be uncomfortable for some users. Further, the use of a keyboard and mouse (or other multi-device configurations) is often inefficient and does not provide superior manipulation of the controls while performing certain tasks.

As opposed to a mouse and keyboard, or system allows for cursor manipulation and text input without taking your hands off the device when both handpieces are used “Duel Mode”, that is left and right hand pieces at the same time.

While the computer mouse is perhaps one of the most common peripheral devices, they have inherent limitations, such as their limited range of motion. They also result in imprecise and clumsy aiming, which is solved via the control elements of the embodiments provided herein. In some cases, users opt for a touchpad (i.e., the index pad) rather than a mouse. However, the touchpads lack usability by being in locations that are not conducive to utility while lacking additional input means such as buttons.

Operating a cursor with a mouse inevitably gives rise to the hand coming to the limit of its workable surface area, prompting the user to lift the device and reposition it to continue operations. The peripheral device uses the combination of fusion sensor, (as previously described) and index pad at the index finger to manipulate, in a fine manner, the position of the cursor while the gross movement of the cursor is handled by the thumb potentiometer (i.e., the thumb stick). Additionally imagine writing your name with a mouse and how inadequate that is. Our device aims to handle this elegantly and comfortably.

In desktop computer applications, switching from one computer peripheral to another often interrupts workflow. Whether you are moving your cursor from one text field to another or making changes within a text body, switching from pointing device to typing device can be very inefficient. The left handpiece is a mirror of the right handpiece. The left index touchpad can be used as a virtual set of buttons (programmable by software and displayed via overlay), until the keyboard overlay is brought up when the user selects a text/data entry box, in which case both index touchpads select keys in the onscreen keyboard using one or more cursors.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the peripheral device, according to some embodiments;

FIG. 2 illustrates a perspective view of the peripheral device, according to some embodiments;

FIG. 3 illustrates a perspective view of the peripheral device, according to some embodiments;

FIG. 4 illustrates a perspective view of the peripheral device and control elements, according to some embodiments,

FIG. 5 illustrates a perspective view of the peripheral device and control elements, according to some embodiments, and

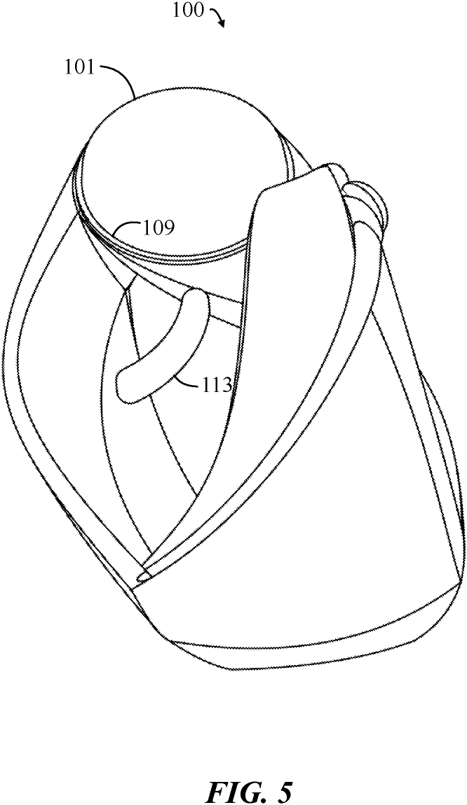

FIG. 6 illustrates a block diagram of the fusion sensor of the peripheral device in operable communication with a computer system, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to an improved peripheral device used to provide an input signal to computing device. Although described as including a specific number, shape, size, type or orientation of components, this is for illustrative purposes only. As such, the inventive system can include any number of distinct controllers, each having any number of different components that are each capable of performing any number of different functions described herein. Moreover, each of the components can be provided along the controller housings at any number of different locations. As described herein, the peripheral device is intended to replace or augment traditional command and control components such as a computer keyboard, mouse, touchpad, joystick, remote control, and/or various vehicular controls, for example.

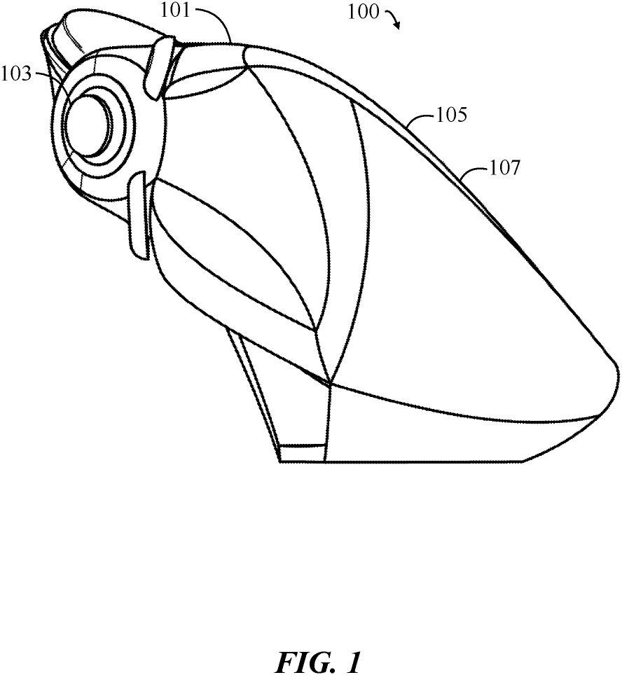

FIGS. 's 1-3 illustrate a perspective view of the peripheral device 100 having a housing 101 configured to ergonomically fit the hands of a user The peripheral device 100 is in wired or wireless communication with a computing device to allow the user to control, via the control elements on the peripheral device 100, a computer program, vehicle, watercraft, aircraft, or other device and applications thereof. FIG. 1 illustrates the peripheral device 100 and housing 101 including the thumb stick 103 which the user manipulates with their thumb to transmit an output signal to the computing device. The thumb stick 103 may include a 2-axis potentiometer or capacitive touch device. A palm ridge 105 extends along a top edge 107 of the housing 101 to provide, at least in part, an ergonomic arrangement of the housing elements.

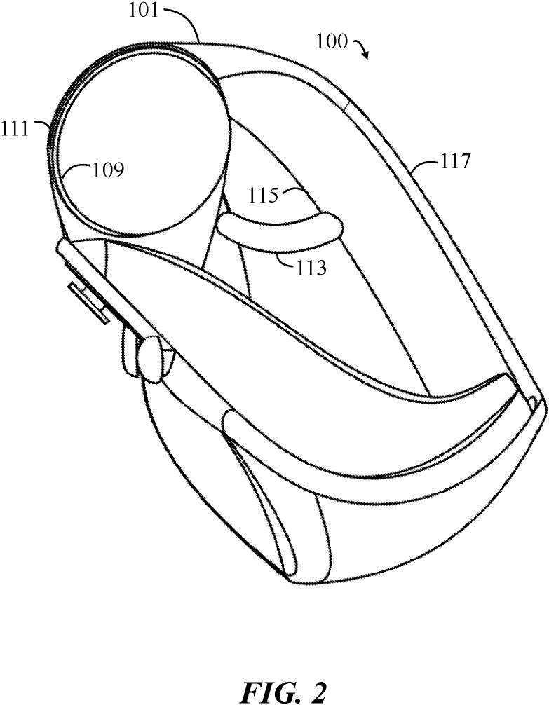

FIG. 2 illustrates a perspective view of the peripheral device 100 wherein an index pad 109 is positioned at the front 111 of the housing 101 The index pad 109 may include one or more sensors or be provided for user comfort to support the index finger(s) during use. A trigger 113 is provided along a central portion 115 of the housing 101. The trigger 113 may be single stage, dual stage, or multi-stage to provide various output signals to the computer. A finger guard 117 is provided to provide an ergonomic fit to the user’s hand and increase comfort during use. Further, the finger guard 117 may prevent inadvertent contact with other peripheral device (eg., a keyboard) and protect the fingers as the device operates on non-traditional surfaces.

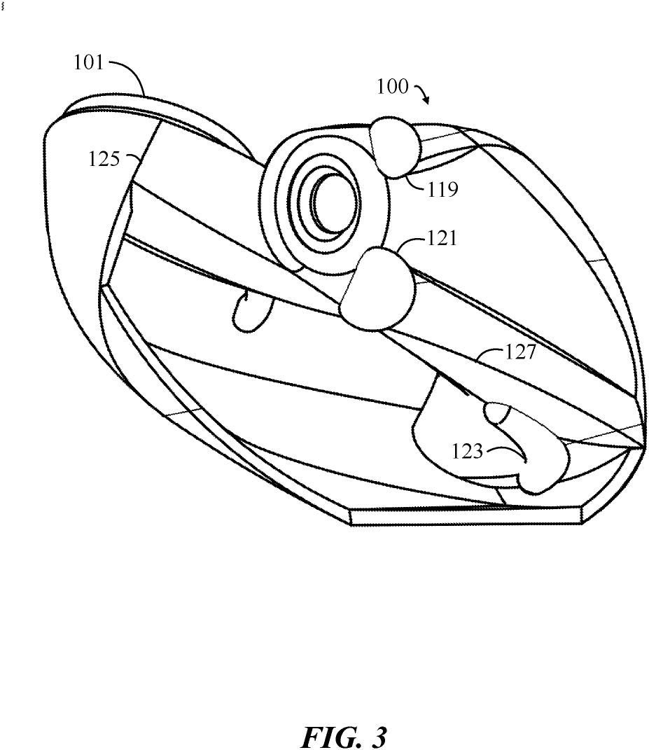

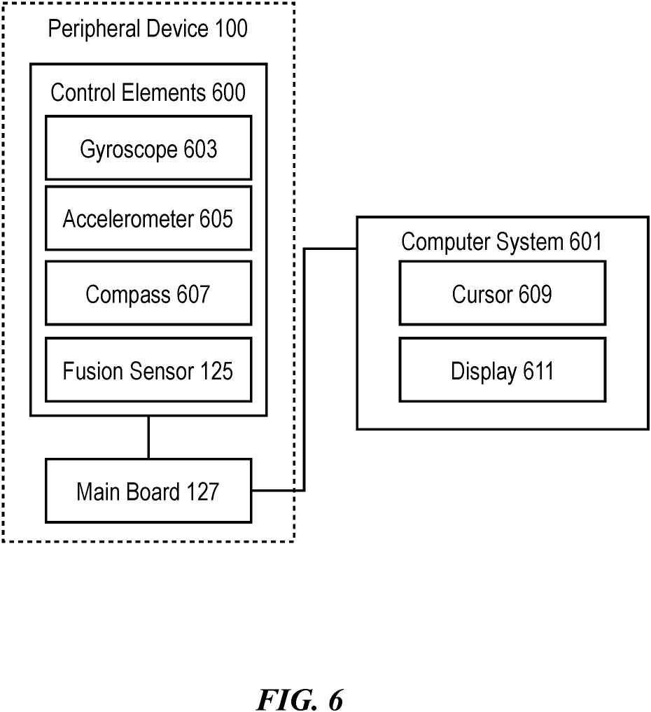

In some embodiments, the index pad 109 is in electrical communication with a fusion sensor 125 (see FIG. 3 and FIG. 6) to provide multi-sensor input to the computer system. The index pad 109 can include various touch sensors, pressure sensors, heat sensors, capacitive touch sensors, motion sensors, and other types of sensors known in the arts. In such, the user can use the various control elements to operate the cursor, keyboard, or other input functions of the computing device.

FIG. 3 illustrates a perspective view of the peripheral device 100 including a first thumb button 119 and a second thumb button 121 each arranged to be manipulated by the thumb of the user. A grip button 123 is provided which may be manipulated by the hand of the user. A fusion sensor 125 and main board 127 are provided in the interior of the housing 101 and facilitate the transmission and reception of the control element signals to the computer The fusion sensor 125 and main board 127 are discussed further in FIG. 6.

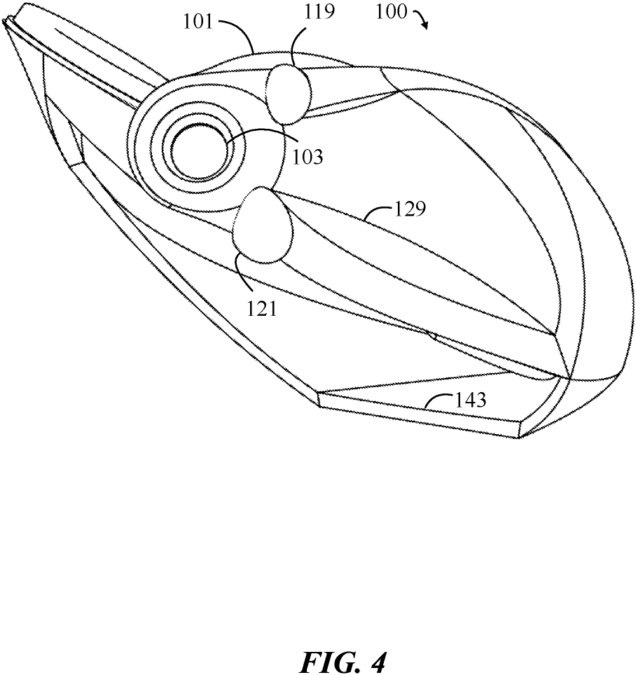

FIGS. 's 4-5 illustrates a perspective view of the peripheral device 100 and control elements thereof. FIG. 4 illustrates a bottom side 129 of the peripheral device 100 which includes the thumb stick which the user manipulates with their thumb. A thumb pad 109 provides ergonomic support and comfort and may include a pressure sensor or other sensing element to capture user input. A palm ridge can be adjusted to accommodate various hand sizes This can be done either by installing the appropriately sized palm ridge, or can be loosened and adjusted for comfort, then resecured. Each of the first and second thumb buttons 119,121 are provided on the housing 101 to allow the user to manipulate each button with their thumb. An index pad 109 provides capacitive or likewise sensors to capture user pressure input and motion input on the index pad 109 In some embodiments, the index pad 109 is operated by the index fingers of the user to allow the user to control various functionalities of a computer program with their index finger rather than a thumb as is common in many controllers. A grip 143 secures the users hand on the housing 101 during use and helps maintain control of the peripheral device 100 during use

FIG. 6 illustrates a block diagram of the control elements 600 in operable communication with the computer system 601. The control elements include the peripheral device 100 controls described in FIGS. 's 1-5 in addition to the fusion sensor 125. The fusion sensor 125 may include a gyroscope 603, accelerometer 605, and compass 607 each sensing motion of the peripheral device 100 The fusion sensor 125 allows the user to perform writing motions to type using the peripheral device without using the keyboard or mouse. Further the fusion sensor 125 may allow for various control functions which may not be possible with a keyboard and mouse traditionally provided on the computing device. In some embodiments, each fusion sensor 125 is embedded within each housing 101 of each peripheral device 100. Each fusion sensor 125 works in tandem to sense user motion of each peripheral device 100. Each fusion sensor 125 provides positional tracking of a cursor 609 provided on the display 611 on the computing device.

As used herein, the term “control elements” may comprise the thumb stick, thumb pad, palm horn, wrist rest, boom hinge, touchpad boom, middle finger button, index finger button, ring finger button, pinky finger button, grip, touchpad, triggers, thumb button(s), finger guard, finger guard, gyroscope, fingerprint scanner, and other elements described herein The control elements may provide tactile feedback (such as by pressing the button), or may support the hand, secure the hand, or the like to allow the user to securely move the peripheral device during use (such as by twisting the device to activate the gyroscope).

Each control element is in operable communication with the fusion sensor to allow for multiple control inputs to be input by the user in real-time. In such, the fusion sensor may receive inputs from the gyroscope, accelerometer, and compass to control one or more cursors on the display of a computing device The user may also select one or more control elements while the fusion sensor is sensing various movements by the user

The peripheral device can include functionality so as to be wired or wirelessly linked to virtually any type of processor enabled device such as a desktop computer, laptop, tablet, smartwatch, gaming system, virtual reality system, augmented reality system, smartphone, and/or smart television, among many others, for example. The peripheral device can include one, but preferably two discrete controllers having any number of different shapes and sizes. In some embodiments, the controllers can be constructed so as to conform to a user’s right and left hands, respectively, so as to maintain each hand in a comfortable ergonomic posture during use. To this end, each controller can include any number of different gripping surfaces that can be positioned along the main body in either a fixed or moveable orientation. The controller bodies can each be constructed from any number of different materials that are for example, relatively strong and stiff for their weight to provide a sufficiently rigid structure. Several nonlimiting examples include, but are not limited to various metals, plastics/polymers and/or various composite materials, for example, so as to provide a sealed interior space for the system electronics. To this end, the interior space may include any number of internal connectors to act as shock absorbers for the electronic components and can also include a seal so as to prevent moisture, dust, or other debris from entering the internal space.

In one embodiment, a plurality of input/output mechanisms can be positioned along each of the controller bodies. Each of the input/output mechanisms can function to receive user inputs and/or provide information to a user holding the respective controller body. To this end, the plurality of input mechanisms can include, any number of buttons, switches, touchscreens, touchpads, levers, joysticks, etc., Likewise, the plurality of output mechanisms can include any number of lights, speakers, tactile/vibration devices, display screens and the like. As noted above, each of these input/output mechanisms can be positioned anywhere along the controllers in either a fixed orientation or in a moveable orientation (e.g., boom hinge moveable touchpad, etc.,).

In one embodiment, each of the controller bodies can include an internally located electronic suite The electronic suite can be communicatively linked to each of the input/output mechanisms and an onboard power supply The electronic suite can include any number of different processing, switching, communication and memory components which can be provided in accordance with known manufacturing techniques, so as to enable each of the controllers to communicate with an external processor enabled device

In one embodiment, the peripheral device can include programmatic instructions for execution on the external processor enabled device These programmatic instructions can include, comprise or consist of any type of computer or machine-readable language so as to allow the system to operate the device. In some instances, the programmatic instructions can allow the peripheral device to perform the same commands as traditional components (e.g., act as a standard keyboard, mouse or remote control). In other instances, the programmatic instructions can impart new functionality into the device, such as providing two different cursors, or performing two different functions simultaneously.

In some embodiments, a computer system may be in communication with the peripheral device and allow the peripheral device to control various aspects of the computer and applications running thereon. The computer system may be utilized to execute various procedures, including the processes described herein. The computer system comprises a standalone computer or mobile computing device, a mainframe computer system, a workstation, a network computer, a desktop computer, a laptop, or the like. The computing device may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). In such, the peripheral device can be used to control applications and/or programs operated by the computing device to provide the user to provide input, control functions, etc.

In some embodiments, the computer system includes one or more processors coupled to a memory through a system bus that couples various system components, such as an input/output (I/O) devices, to the processors. The bus may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus. In such, the processor(s), memory, and I/O devices may be operated via the computer system and/or the peripheral device to execute the functionalities described herein.

In some embodiments, the computer system includes one or more input/output (I/O) devices, such as video device(s) (e.g., a camera), audio device(s), and display(s) are in operable communication with the computer system which may each be controlled, manipulated or interacted with using the peripheral device(s). In some embodiments, similar I/O devices may be separate from the computer system and may interact with one or more nodes of the computer system through a wired or wireless connection, such as over a network interface. In some embodiments, the I/O device may be used in tandem with the peripheral device(s) described by the embodiments presented herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment A processor can also be implemented as a combination of computing processing units.

In some embodiments, the memory includes computer-readable application instructions, configured to implement certain embodiments described herein, and a database, comprising various data accessible by the application instructions. In some embodiments, the application instructions include software elements corresponding to one or more of the various embodiments described herein. For example, application instructions may be implemented in various embodiments using any desired programming language, scripting language, or combination of programming and/or scripting languages (e.g., C, C++. C#, JAVA, JAVASCRIPT, PERL, etc.).

Component one is an index pad distal to the position of the index finger to allow the user to input various controls using each index finger.

In some embodiments, the position of the thumbpad can be changed to accommodate larger or smaller hands. The thumb pad is loosened to allow a sliding joint to extend or retract the housing. This puts the tip of the thumb in line with the thumb stick and the buttons to ensure comfort and convenience to most hand sizes.

In some embodiments, a palm horn can be adjusted to accommodate various hand sizes. This can be done either by installing the appropriately sized palm horn, or can be loosened and adjusted for comfort, then resecured

In some embodiments, the peripheral devices can be used to operate various computer programs, applications, games, etc The peripheral devices may be used to control or otherwise interact with virtual reality (VR) and/or augmented reality (AR) programs. In some embodiments, the peripheral devices include motion tracking elements for VR and/or AR applications.

In some embodiments, the peripheral devices, when used in tandem, may track their relative position to one another. In such, each peripheral device is spatially aware with reference to one another, with reference to the user, and/or with reference to other devices.

In some embodiments, each touchpad includes a pressure sensor capable of measuring and quantifying contact thereto. In such, input can be altered based on pressure applied to the touchpad. This may be useful for controlling aspects of a program wherein the applied pressure changes an input to the application controls.

In some embodiments, each touchpad is multi-touch compatible to allow multiple fingers to interact with the touchpad at the same time. This may be useful for inputting unique controls wherein two simultaneous contacts with the touchpad produce a different output than only contacting the touchpad at a single point. For example, contacting the touchpad simultaneously with two fingers may initiate a “double click” of a cursor on the user interface.

In some embodiments, the peripheral device includes a fingerprint sensor. This may be used for various security protocols, such as to access specific games, access content, or to turn the peripheral device on or off One skilled in the arts will readily understand that various functionalities of the fingerprint sensor may utilized.

In some embodiments, the peripheral device may include one or more I/O devices such as a microphone and speaker(s). In such, the user can input an audio signal which is captured by the microphone. The speaker(s) may emit an audible sound corresponding to gameplay, instructions, alerts, or other useful sounds which enhance the user’s experience.

In some embodiments, the peripheral devices each include a strap or magnetic counterforce which can be positioned around the body (e.g., the wrist) of the user. This provides a degree of safety when using the devices and prevents the user from accidentally throwing or dropping the peripheral devices during use. The strap(s) may be affixed to the peripheral devices by tying them to a receiver, or by magnetic attachment

The peripheral devices may be used as controllers for various games, simulations, applications, or as a general-purpose controller. For example, the peripheral devices may be used as an automotive interface for operating a vehicle and interacting with vehicle systems. The peripheral devices may be suitable for operating aircraft remotely or during standard crewed piloting operations. Further, the peripheral devices can be used to control watercraft, robotics, and simulations thereof.

In some embodiments, the peripheral devices each include a gyroscope to facilitate control of a cursor, or other aspects of a computer application. One skilled in the arts will readily understand that the gyroscope can be used to control various aspects of the computer application, vehicle, or other device which is in operable communication with the peripheral devices. In some embodiments, the gyroscope is used in conjunction with an accelerometer and compass (collectively called the “fusion sensor”) to augment data sent from the touchpad to give accurate positional information that more precisely mimics how one would write with a finger, pen, or other writing instrument.

We can use a thumb stick to change the cursor field and a touchpad to move that cursor within that field. This leverages the strengths of both devices without asking them to do what they are both inherently poor at.

Similarly, touchpads do the aiming, making use of one of the most precise fingers, our index finger.

Four analog inputs each with two axes provide more than enough axis of freedom for modern games.

Our product can be used on a desk or couch without impeding precision or speed, ensuring you don’t lose your edge due to your choice of seating.

Our touchpads are placed within easy reach of the index finger of each hand without bringing our other digits out of position to be used.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A peripheral device for a computer, the peripheral device comprising:
a housing including an interior to contain a fusion sensor in electrical communication with a one or more control elements, the control elements comprising at least one of the following:
a thumb stick to interface with a thumb;
an index pad to interface with an index finger;
a trigger to interface with a middle finger;
a first thumb button and a second thumb button each to interface with the thumb, wherein the fusion sensor includes a gyroscope, an accelerometer, and a compass each to sense motion of the peripheral device, wherein the fusion sensor and control elements provide input to a cursor displayed on a computing device.

2. The peripheral device of claim 1, further comprising an adjustable thumb pad to accommodate various hand sizes.

3. The peripheral device of claim 2, wherein the thumb pad is loosened to allow a sliding joint to extend or retract the housing.

4. The peripheral device of claim 1, further comprising an adjustable palm horn adjustably connected to the housing to accommodate various hand sizes.

5. The peripheral device of claim 1, wherein the peripheral device is provided as a pair of devices, including a first peripheral device and a second peripheral device, the first device configured to be operated by a right hand and the second device configured to be operated by a left hand.

6. The peripheral device of claim 5, wherein the first device and the second device are operated in tandem to provide simultaneous input to the computer.

7. The peripheral device of claim 1, wherein the peripheral device operates an augmented reality application operable via the computer.

8. The peripheral device of claim 1, wherein the peripheral device operates a virtual reality application operable via the computer.

9. The peripheral device of claim 1, further comprising a fingerprint sensor to analyze the fingerprint of the user.

10. The peripheral device of claim 1, further comprising a fingerprint sensor to analyze the fingerprint of the user, wherein the fingerprint sensor is in operable communication with a fingerprint analysis module to analyze the user’s fingerprint and compare the fingerprint with a plurality of fingerprints stored in a fingerprint database to determine if the fingerprint is accepted to access the peripheral device or the computer.

11. A peripheral device for a computer, the peripheral device comprising:
a housing including an interior to contain a fusion sensor in electrical communication with a one or more control elements, the control elements comprising at least one of the following:
a thumb stick to interface with a thumb;
an index pad to interface with an index finger;
a trigger to interface with a middle finger;
a first thumb button and a second thumb button each to interface with the thumb, wherein the fusion sensor includes a gyroscope, an accelerometer, and a compass each to sense motion of the peripheral device, wherein the fusion sensor and control elements provide input to a cursor displayed on a computing device, wherein the fusion sensor is in electrical communication with a main board to transmit sensor inputs to the computing device, wherein a first peripheral device is held by a first hand of a user and a second peripheral device is held by the second hand of the user, and wherein the first peripheral device and the second peripheral device each operate in tandem to provide input the cursor.

12. The peripheral device of claim 11, further comprising an adjustable thumb pad to accommodate various hand sizes.

13. The peripheral device of claim 12, wherein the thumb pad is loosened to allow a sliding joint to extend or retract the housing.

14. The peripheral device of claim 13, further comprising an adjustable palm horn adjustably connected to the housing to accommodate various hand sizes.

15. The peripheral device of claim 14, wherein the peripheral device operates an augmented reality application operable via the computer.

16. The peripheral device of claim 15, wherein the peripheral device operates a virtual reality application operable via the computer.

17. The peripheral device of claim 16, further comprising a fingerprint sensor to analyze the fingerprint of the user.

18. The peripheral device of claim 17, wherein the main board interprets an input from the index pad in tandem with an input sensed by the fusion sensor to provide input to a cursor or a keyboard in communication with the computing device.

19. The peripheral device of claim 18, wherein the fusion sensor permits the user to write using each of the first and the second peripheral devices.

20. A dual peripheral device for a computer, the peripheral device comprising:
a housing of a first peripheral device and a housing of a second peripheral device including an interior to contain a fusion sensor in electrical communication with a one or more control elements, the control elements comprising:
an at least one index pad to interface with an index finger to receive an input from the user’s index finger, the at least one index pad positioned distal to the index finger on a front of the housing, the housing configured to ergonomically fit the hand of the user,
wherein the fusion sensor includes a gyroscope, an accelerometer, and a compass each to sense motion of the peripheral device, wherein the fusion sensor and control elements provide input to a cursor displayed on a computing device, wherein the fusion sensor is in electrical communication with a main board to transmit sensor inputs to the computing device, wherein the first peripheral device is held by a first hand of a user and the second peripheral device is held by the second hand of the user, and wherein the first peripheral device and the second peripheral device operate in tandem to provide input to the a cursor.
